(19) United States
(12) Patent Application Publication
(10) Pub. No.: US 2012/0079563 A1
(43) Pub. Date: Mar. 29, 2012

(54) METHOD AND APPARATUS FOR MINIMIZING NETWORK VULNERABILITY VIA USB DEVICES

(75) Inventors: Paul Green, Annapolis, MD (US); Riley Porter, Silver Spring, MD (US)

(73) Assignee: G2, Labs LLC., Annapolis Junction, MD (US)

(21) Appl. No.: 13/182,240

(22) Filed: Jul. 13, 2011

Related U.S. Application Data
(63) Continuation-in-part of application No. 12/730,896, filed on Mar. 24, 2010.
(60) Provisional application No. 61/363,900, filed on Jul. 13, 2010.
(60) Provisional application No. 61/162,907, filed on Mar. 24, 2009.

(51) Int. Cl. G06F 21/00; G06F 21/24; G06F 13/14

(52) U.S. Cl. 726/3; 710/305; 726/28; 710/18

(57) ABSTRACT

A device for preventing the rewriting and revision of the firmware installed on one or more USB devices, the device including a male Universal Serial Bus (USB) connector for connecting the device to a host, a female USB connector for receiving the USB device, an integrated circuit, and a detector blocking the transmission of a device firmware update (DFU) from the host to USB device.

### CROSS-REFERENCE TO RELATED APPLICATIONS

This application claims priority to and benefit of U.S. Provisional Patent Application Ser. No. 61/363,900 entitled “METHOD AND APPARATUS FOR MINIMIZING NETWORK VULNERABILITY VIA USB DEVICES” to Paul Green, filed in the United States Patent and Trademark Office on Jul. 13, 2010, the entire contents of which are herein incorporated by reference. The present application also claims priority to, the benefit of, and is a continuation-in-part of U.S. patent application Ser. No. 12/730,896 to Green et al. filed on Mar. 24, 2010, which claims priority to and benefit of U.S. Provisional Patent Application Ser. No. 61/162,907 filed on Mar. 24, 2009, both entitled “METHOD AND APPARATUS FOR MINIMIZING NETWORK VULNERABILITY,” the entire contents of both of which are incorporated herein by reference.

### TECHNICAL FIELD

The present disclosure relates to methods and devices for preventing unauthorized access to computer networks. More particularly, the present disclosure is directed to preventing unauthorized access of a computer on a network via a Universal Serial Bus (USB) device and limiting the time available for exploiting the computer.

### BACKGROUND

In order to exploit a computer network system, an adversary requires three things: time, some vulnerability, and a way (vector) of exploiting that vulnerability. If it is assumed that all systems have vulnerabilities, then it is reasonable to assert that the longer a computer is attached to a network the greater the chance that it can be compromised. Thus the most valuable resource computer network operators unwittingly provide to electronic adversaries is time.

Nonetheless, currently most attention is directed at vulnerability prevention, and after a network node is compromised, management and remediation. But most of the current vulnerability prevention technologies are ineffective and are continually overcome by events, new technology, and the adversary's techniques. For example, in the case of a compromised computer operating on a network, a common approach used by adversaries is to install a nearly undetectable backdoor software application called a rootkit. The rootkit provides access to the network via the computer even after the original vulnerability has been detected and patched. Indeed, some of these backdoors have been found to survive actions including reinstallation of the computer operating system (See e.g., Reversing and exploiting an Apple firmware update, K. Chen (2009)).

Additionally, by an attacker's placement of the malware, rootkit, or a hypervisor in a lower ring (ring-1) of the system, a network administrator taking active steps to neutralize an attack or to close the window to potential future attacks cannot be confident that such actions have been successful. See Sub Virt: Implementing malware with virtual machines, S. King et al. (2009). Even further, it has been found that in some instances the computer manufacturers themselves, with no perceived malicious intent, and with some reasonable justification (anti-theft technologies) install backdoor programs, which provide the manufacturers with remote system access. These manufacturer-installed backdoors can, and have been known to implement rootkit technologies allowing complete control of the computer. (see http://en.wikipedia.org/wiki/Sony_BMG_copy_protection_rootkit_scandal). More importantly, backdoors, by their intended function, may be very persistent in order to survive a system wiping as typically occurs after a computer is stolen. (Deactivate the Rootkit: Attacks on NIOS anti-theft technologies, A. Ortega et al. (2009)). As reported by Ortega, these anti-theft features can be, and have been, exploited because the manufacturer-installed backdoors do not include strong authentication.

The stark reality is that most machines/systems/networks have already been compromised. And while there are good reasons for continued focus on vulnerability prevention and management, these will continue to provide only limited results. Indeed, these are ineffective solutions, with each new patch being circumvented by the next compromise technique.

In light of these difficulties a new approach has been contemplated wherein the focus shifts to the temporal aspects of an attack. In co-pending U.S. application Ser. No. 12/730,896 entitled Method and Apparatus for Minimizing Network Vulnerability, which is fully incorporated herein by reference, there is described methods and devices for limiting the time available for malware to utilize an infected computer by monitoring the usage of the I/O from a keyboard or a mouse and after a predetermined time of inactivity severing the connection between the computer and the network on which it operates. Thus, the malware is denied time to gather information via the infected computer, or to provide that information to the adversary who caused the computer to be infected in the first place. The system described in the '896 Application further teaches that depending upon the type of malware the computer is infected with, the adversary who caused the infection is prevented from being able to take over the computer to access the network via remote operation of that computer. Such a simple system is quite effective where simple devices are involved, particularly the PS2 type keyboards described in the '896 Application.

As noted above, it was recently reported that the USB devices' firmware may present a vulnerable avenue for attacking a computer or network. (Chen, 2009). As described by Mr. Chen, poorly designed devices residing on a computer's USB bus can present a serious security flaw. The flaw comes from the updatable nature of the firmware, through a device firmware update (DFU). Specifically, the low cost of the microcontrollers incorporated in many of these devices, mean that they have few if any security features, and can be readily exploited as an attack vector for the computer itself. Thus, an attacker can tamper with the firmware of the keyboard and embed malware. Moreover, even if detected, such malware will likely survive a clean reinstallation of the computer's operating system since such actions generally do not affect the firmware of the connected USB devices.

That the firmware of a USB device can be altered from its original form is not surprising, indeed, this has been one of the features of the USB protocol for over a decade. As described by the Universal Serial Bus Device Class Specification for Device Firmware Update, Version 1.0 (May 13, 1999), “purchasers of USB devices require the ability to upgrade the firmware of the devices with improved versions.” As shown in FIG. 10, which is taken from the Device Firmware Update, by design, the firmware in USB auxiliary devices, including keyboards and mouse, are intended to be altered.

More troubling is that the security provisions included with the firmware on typical USB devices is extremely limited, if it exists at all. In addition, for a variety of reasons, the manufacturers of the auxiliary devices routinely provide updates to the firmware in order to optimize its performance, upgrade features, etc., thus providing yet another vector for attacking the firmware of a USB device.

In view of this newly identified vector for attacking a computer to gain access to the computer or more damagingly the network on which it is installed, a new approach is necessary to limit the access to and time available to infect a computer by an attacker.

### SUMMARY OF THE DISCLOSURE

One aspect of the present disclosure is directed to a device and method for preventing the rewriting and revision of the firmware installed on a USB device such as a keyboard or mouse.

A further aspect of the present disclosure is directed to a device and method for dynamic protocol filtering for USB devices to limit the rewriting and revision of the firmware installed on a USB device such as a keyboard or mouse as defined by a user or administrator.

Another aspect of the present disclosure is directed to a device and method for preventing the rewriting and revision of the firmware installed on a USB device such as a keyboard or mouse incorporated on a USB ported device connected between a host device and the USB device.

Still another aspect of the present disclosure is directed to a device and method for preventing the rewriting and revision of firmware installed on a USB device that could be utilized to enable access to networks to which the computer is connected via remote virtual actualization of the USB devices.

Yet a further aspect of the present disclosure is directed to a device and method for preventing the rewriting and revision of certain firmware installed on a USB device and for controlling access to a network.

Other features and advantages of the disclosure will appear from the following description in which the preferred embodiments have been set forth in detail, in conjunction with the accompanying drawings.

### BRIEF DESCRIPTION OF THE DRAWINGS

FIG. 1 is a schematic of a system according to a first aspect of the present disclosure;

FIG. 2 is a flow chart showing a second aspect of the present disclosure;

FIG. 3 is a flow chart showing a third aspect of the present disclosure.

FIG. 4 is a flow chart showing a fourth aspect of the present disclosure.

FIG. 5 is a flow chart showing a fifth aspect of the present disclosure.

FIG. 6 is a flow chart showing a sixth aspect of the present disclosure.

FIG. 7 is a flow chart showing a seventh aspect of the present disclosure.

FIG. 8 is a data byte according to one aspect of the present disclosure.

FIG. 9 is a thumb device according to one aspect of the present disclosure.

FIG. 10 is a prior art rendering depicting the transmission of data from a host device to a USB device for updating the firmware of the USB device.

### DETAILED DESCRIPTION OF THE PREFERRED EMBODIMENTS

A USB device, such as a keyboard or a mouse, contains firmware that can be attacked, or better stated can be the platform from which to launch an attack (e.g., using an attack vector). One concern is the ability of someone to attack the USB device in such a manner that the device, i.e., its firmware, is overwritten to include the installation of a backdoor to which the attacker could return and gain access to the computer itself and/or the network to which it is connected. For example the keyboard firmware, if altered as described by Chen, could act as a key stroke logger and result in an effective and potentially crippling type of hack allowing access to any number of networks from a single entry point or infected host machine.

Accordingly, one aspect of the present disclosure involves limiting access to the keyboard firmware at the protocol level by creating a USB firewall preventing the DFU. Although the embodiments described herein use the term “firewall,” other detectors may be used, e.g., a proxy firewall, a passive sniffer with a signal disconnect, an intrusion prevention system, a relay, or other device or software that can selectively allow or disallow the transmission of data. This can be undertaken either in software on the host device, at the USB device itself, or as part of an intermediary component located between the host device and USB device.

Additionally or alternatively, according to another aspect of the present disclosure, other firewalls may be used to prevent updating of firmware on a device. For example, in some embodiments, the USB firewall may be replaced by a HDMI firewall, a firewire firewall, a SCSI firewall, a fibre channel firewall, and the like for preventing any communications for updating firmware.

One implementation of the USB firewall is in a small thumb drive style USB connectable device, referred to herein as a thumb device. The thumb device is plugged into one of the host device USB ports and also includes a USB port of its own through which the USB device (e.g., keyboard or mouse) is connected to the host device. Thus, the thumb device is physically between the keyboard and the host device. The firewall (either as software or firmware) on the thumb device acts as a decision engine monitoring the data stream between the host device and the USB device and simply prevents DFU from reaching the USB device. In one application all other functions and data are allowed to pass through unmolested and only the DFU is prevented, however those of skill in the art will recognize that other functions and data could be similarly prevented.

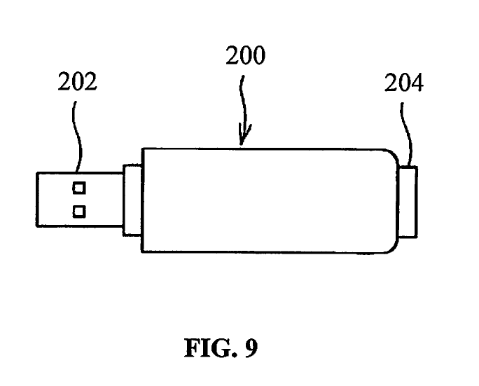

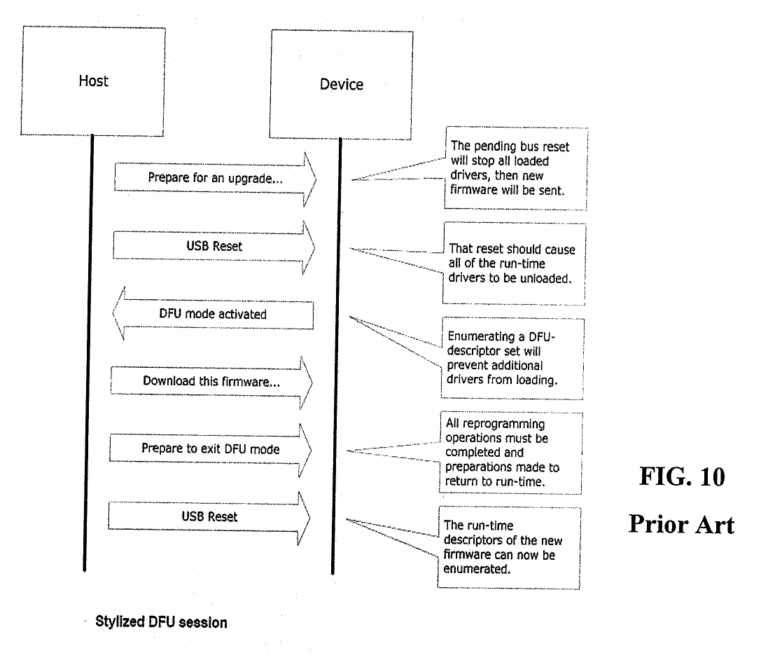

An example of the thumb device 200 is shown in FIG. 9 where one end features a male USB connector 202 for connecting the thumb device 200 to a USB port of the host device. The thumb device also includes an integrated circuit or microcontroller (not shown) which undertakes the firewall activities. The firewall will at minimum have the ability to monitor the data streams being sent to the USB device (i.e., the keyboard or mouse) and prevent the DFU from being transmitted from the host device to the USB device. Further, the thumb device 200 includes a female USB connection port 204 through which the USB device is connected to the host device.

A further aspect of the present disclosure is directed to application level protocol filtering. The filtering can be of two types. The filtering can be static, thus for example, blocking all DFU functions for all USB devices connected to the host. This for example, may be a preferred method of implementing the thumb device firewall described above. Alternatively, the filtering can be dynamic (configurable) by the user or administrator. For example, the USB firewall may prevent firmware updating when there is no physical I/O communication to and from a device (e.g., a keyboard) and the host device I/O for a predetermined period of time and a pop-up box may request a confirmation of the firmware update while requiring that physical I/O communication occur within a predetermined recent amount of time. The dynamic type application level filtering may permit DFU or other functions for only certain classes or types of devices, from certain recognized sources, or following a response to a “are you sure” prompt while preventing all other DFU functions. As noted above, other functions could also be blocked by the application level filtering. Such an embodiment would operate similarly to a pop-up blocker. Thus, by preventing, for example the DFU, a would-be hacker is prevented from altering the firmware of the keyboard, but all other data streaming to and from the keyboard is permitted. Preferably, the configurable filtering is implemented as software in the host device, however, other implementations are also considered within the scope of the present disclosure including as firmware or software on a standalone device such as the thumb device described above or a network connection controlling device as will be explained below. Accordingly, a further aspect of the present disclosure is the incorporation of the USB firewall into a device that also monitors physical I/O to and from a keyboard and which removes the host device for a network it is connected to when there is no physical I/O for a predetermined period of time.

As described in the co-pending and commonly assigned '896 application, heretofore, little attention has been spent focusing on the time aspects of network security. By limiting the time that a computer or other host device is on a network to only those times when a user is actually using those devices, the period of time that the device is vulnerable to attack is greatly reduced.

One metric of “actual use” is the time when a physical I/O signal is being generated by peripheral device, e.g., when actual signals are generated by the depression of keys or the movement of a mouse by a user physically sitting at a computer terminal. According to a further aspect of the present disclosure, in the absence of I/O signals from the keyboard or mouse (or any other peripheral device), the computer is disconnected from the network so that an adversary cannot use another computer on the network to gain unauthorized access to the computer. Thus, a further aspect of the present disclosure limits a computer's ability to communicate with a network to those periods of time when an intended user is physically at the computer generating physical I/O signals via the USB devices (e.g., the mouse or keyboard).

By monitoring the I/O signals originating from USB devices and by severing the connection between the computer and the network after a predetermined period of inactivity, the adversary or the software produced by the adversary is denied the necessary time to access the target computer or network and gather desired information. Further, depending upon the type of malware or rootkit the computer is infected with, the adversary who caused the infection is prevented from being able to takeover the computer to access the network via remote operation of that computer.

In a one embodiment, the network security device is implemented at the hardware-level and does not rely on any software that runs on the computer's operating system. Implementing the security system at the hardware level makes it more difficult for an adversary to exploit the security aspects of the disclosure via software measures.

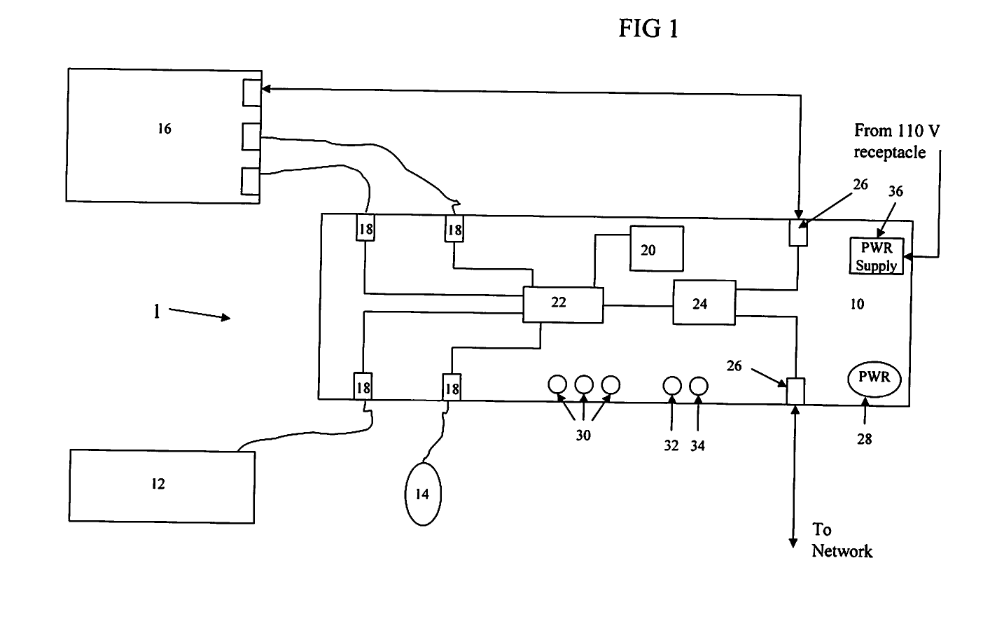

FIG. 1 depicts an aspect of the present disclosure in which system 1 includes a stand-alone security device 10 that can sever the connection between a computer 16 and a network upon sensing a failure to receive physical I/O signals from the keyboard 12 or mouse 14 for some predetermined period. To limit the time available to any malware or rootkit, a switch or relay 24 is employed to limit the connection to the network only to those times during which physical I/O signals are being transmitted from the keyboard 12 or mouse 14 to the computer 16. In one configuration, as shown, the security device 10 is a physical component separate from the computer to which the keyboard 12 and mouse 14 are connected. One of skill in the art will appreciate that this system could be incorporated onto a computer's network interface card (NIC) and made part of the computer 16.

The security device 10 includes inputs and output ports 18 that are connectable to the computer 16 and to the mouse 14 and keyboard 12 (and other peripheral devices not shown). The security device 10 allows the I/O signals sent from the peripheral devices 12, 14 to reach the computer 16 and I/O signals sent from the computer 16 to reach the USB peripheral devices 12, 14. The I/O signals transmitted from the mouse 14, keyboard 12, and computer 16 are received by the microcontroller 22 in the security device 10, and passed along to the intended device. The microcontroller 22 may be, for example, a MSP430F2013 or MSP430G2013 integrated circuit manufactured by Texas Instruments. A JTAG port (not shown) may also be incorporated into the security device for the programming of the microcontroller 22. The functionality of the microcontroller 22 may be hardcoded such that the microcontroller 22 installed by the manufacturer cannot be re-flashed or altered by an attacker, thus preventing circumvention of the security device 10. This may, for example, be accomplished by causing a fuse in the JTAG port to blow after the manufacturer installs the necessary firmware in the security device 10. This feature could be particularly useful when implementing the static firewall proxy or application level protocol filtering where the administrator or user wants to guarantee that DFU is prevented. In such an application the microcontroller 22 would include the firewall proxy software and would monitor the data stream to and from the keyboard 12 or mouse 14 preventing the DFU.

The network connections 26 connect the computer 16 to the security device 10 (e.g., via a standard RJ45 connection) and they connect the security device 10 to the network. The security device 10 also includes a third integrated circuit that is used to regulate the voltage used to power the security device shown in FIG. 1 as power supply 36. For example, the power supply 36 may be a TPS77633 constant-voltage power supply manufactured by Texas Instruments. The TPS77633 controls the voltage of the security device 10 in one embodiment at a constant 3.3 volts.

Elements 32 and 34 are light emitting diodes (LEDs). Element 32 is the active LED and when illuminated indicates that the switch or relay 24 is closed and that the computer is actively connected to the network. Element 34 is the inactive LED and when illuminated indicates that the computer is no longer connected to the network and that the relay is open. These LEDs provide a visual indicator of the status of the security device 10 and the relative security of the computer at all times.

Incorporated within the security device 10 is a relay 24 that opens when the microcontroller 22 senses the absence of signals sent from one or more peripheral devices for a predetermined period, which may be set in the timer 20. When the relay 24 opens, the two network connections 26 are disconnected from each other, isolating the computer 16 from the network. Though shown as a separate component, one of skill in the art will appreciate that the timer 20 may be embodied as software executed by the microcontroller 22. The microcontroller 22, in addition to passing I/O signals to and from the mouse 14 and keyboard 12, also senses whether physical I/O signals from the keyboard 12 or the mouse 14 are being received at the microcontroller 22. Whenever a physical I/O signal is received, the timer 20 resets to 0 and restarts counting time.

Upon the expiration of a certain time period, the timer 20 causes the microcontroller 22 to send a signal to the switch or relay 24 causing the switch or relay 24 to open and sever the connection between the computer 16 and the network. In some embodiments, the microcontroller 22 may be configured to continually transmit a signal to the relay 24 to keep it closed. In these embodiments, upon the expiration of a certain time period, the timer 20 causes the microcontroller 22 to discontinue transmitting a signal to the relay 24 causing the relay 24 to open. The switch or relay 24 may, for example, be a TS3L100PW integrated circuit manufactured by Texas Instruments.

To limit the difficulties for the user, upon the striking of a key on the keyboard 12 or using of the mouse 14, the reception of verified, physical, I/O signals at the microcontroller 22 causes the relay 24 to again close, reestablishing the connection to the network and resetting the timer 20. In a preferred embodiment, this re-connection of the network to the computer 16 will appear seamless such that the user could not detect it.

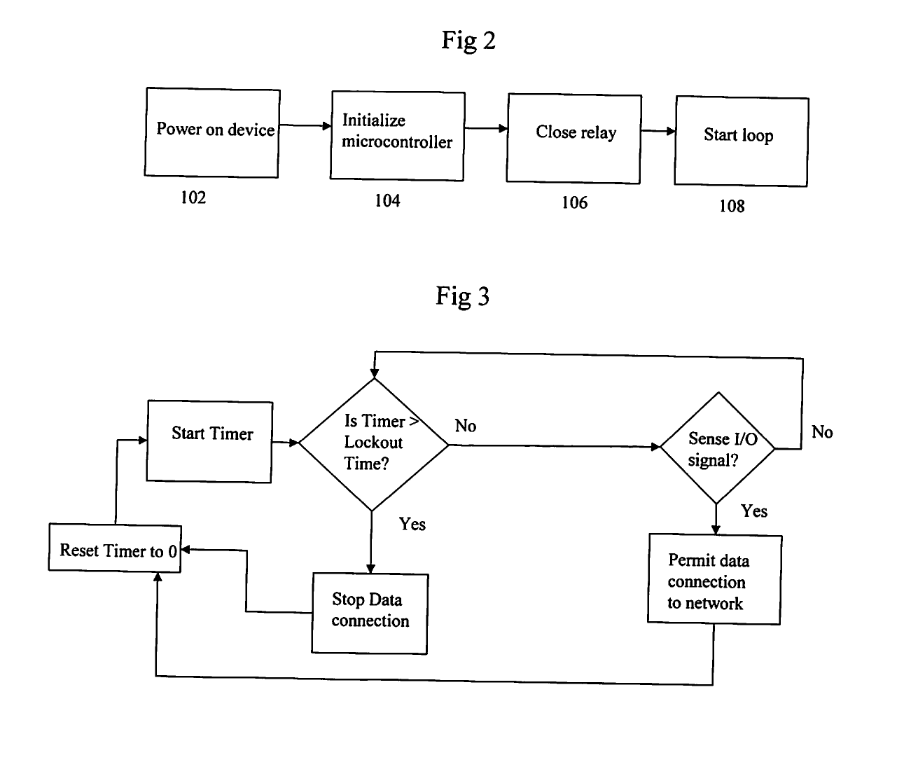

FIG. 2 is a flow diagram depicting operation of certain aspects of the microcontroller 22 within the security device 10. Following depression of the power-on button 28 of the security device 10 in step 102, the microcontroller 22 is initialized in step 104. Initialization of the microcontroller 22 may include reading out of memory instructions that tell the microcontroller 22 which of its pins are inputs and which are outputs. The input pins include pins that receive keyboard and mouse I/O, keyboard and mouse clock signals, and/or a timer signal. The output pins include pins through which various LEDs are turned on with a voltage signal. The LEDs include active LED 32 and inactive LED 34, as well as level indicator LEDs 30 which visually depict, for example, the duration of the lockout time set by the user.

The switch or relay 24 connections may also be configured as outputs of the microcontroller 22, thus allowing the microcontroller 22 to control the opening and closing of the switch or relay 24. Certain variables are also read out of memory, for example, an initial lockout value, that is, a value representing the length of time the switch or relay 24 may remain closed without the microcontroller 22 receiving further I/O signals from the keyboard 12 or mouse 14, after which the switch or relay 24 is opened and the connection to the network is severed. Other variables may include an initial timer value.

Following initialization, software instructions cause the microcontroller 22 to close the relay 24, at step 106. Having closed the switch or relay 24, a connection between the computer 16 and the network is established, and the control loop, as shown for example in FIG. 3, is begun at step 108.

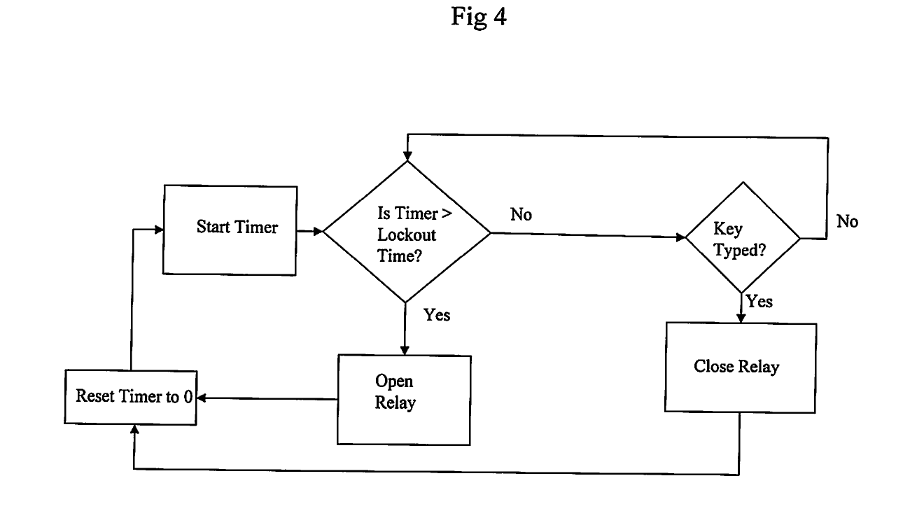

The control loop, as shown in FIGS. 3 and 4, may be a software implemented control loop through which the security device monitors the physical I/O signals received from the user via the keyboard 12 and the mouse 14 to ensure that the computer 16 is being physically operated. As noted above, one of the variables that may be established during initialization of the microcontroller 22 is the lockout timer. The lockout time is the duration of time that may transpire between key strokes or movement of the mouse and still maintain a connection between the computer 16 and the network. To begin the control loop, the timer is started. Once started, the first inquiry is whether the timer value exceeds the set lockout time. If the answer is yes, then a signal is sent from the microcontroller 22 to the switch or relay 24 causing the relay to open and thus severing the connection between the computer 16 and the network. This also causes the timer to be reset to 0, and restarts the running of the timer.

If the answer to the first inquiry is no, then a subsequent inquiry is made to determine whether there has been any physical I/O signal sent from the keyboard 12 or mouse 14 to the computer through the security device 10. If the answer to this second inquiry is no, then the first inquiry regarding whether the timer value exceeds the lockout time is repeated. This loop continues until either the timer value exceeds the lockout time, in which case the network connection is severed, or the microcontroller senses the transmission of a physical I/O signal from the key board 12 or mouse 14. When this physical I/O signal is sensed, the microcontroller 22 causes the relay 24 to close and the data connection between the computer and the network is permitted.

In the event the network connection is already established and the relay 24 is already closed, then the network connection is simply maintained. Following either the permitting of the network connection or maintaining the network connection, the timer is reset to 0 and the steps described above are repeated in a continuous fashion either permitting or stopping the data connection between the computer 16 and the network depending on whether the security device senses an I/O signal.

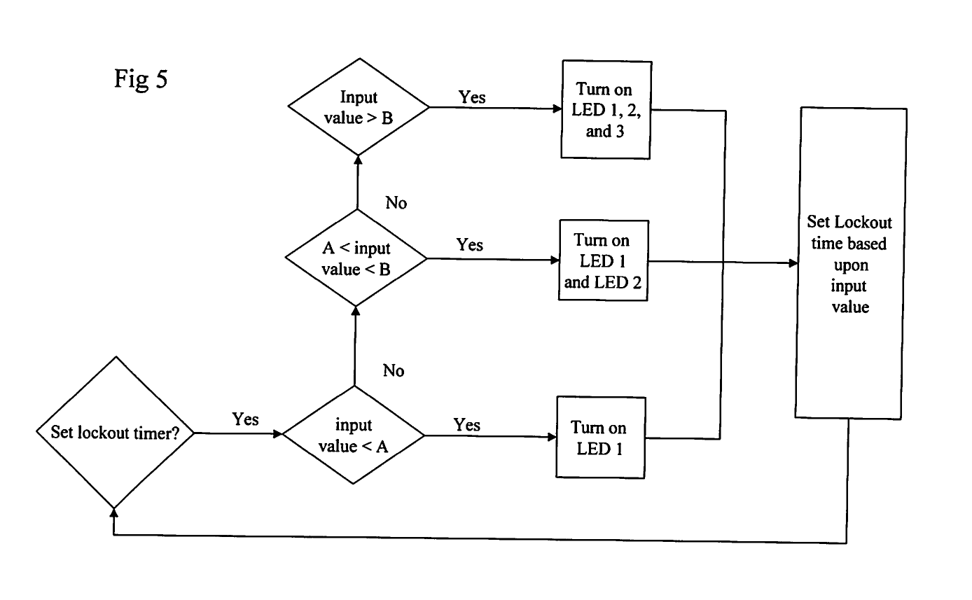

Another aspect of the present disclosure is the setting of the lockout time by the user or manufacturer, as shown in FIG. 5. Again, this implementation may be performed using software that is executed by the microcontroller 22. In FIG. 1, a power button 28 is shown. In one embodiment of the present disclosure, a user, after powering on the security device 10, may press and hold the power button 28. After sensing that the power button 28 has been depressed for greater than a predetermined duration of time, for example 3 seconds, the microcontroller 22 enters a set lockout time mode. Upon sensing that the user wishes to enter the set lockout time mode, and with the user still holding the power button 28, the microcontroller further senses the length of time the power button 28 is depressed.

If the power button 28 is depressed for less than a time A, for example, 5 seconds, then only a first LED 30 is switched on. If the power button 28 is held for a duration between times A and B, for example, between 5 and 15 seconds, then the first and a second LEDs 30 are switched on. And if the length of time a user holds the power on button exceeds a duration B, for example, longer than 15 seconds, then LEDs 1-3 are all switched on. Following depression of the power button 28 for any period of time and the switching on of one or more of the LEDs, then the microcontroller sets the lockout time based upon the length of time the power button 28 was depressed in connection with a pre-set correlation value. For example, holding the power on button for between 5 and 15 seconds may correlate to a lockout time of 30 seconds. One of skill in the art would readily understand that other times and correlations would be possible and the above is merely an example thereof.

The LEDs provide a visual indicator to the user of the length of the lockout time, that is, the length of time between either keystrokes or movement of the mouse to create physical I/O signal without severing the connection between the computer 16 and the network. As will be appreciated, the shorter the duration of the lockout time the greater the security for the computer.

Depending upon the application, the manufacturer can set a series of ranges that the user can utilize for the lockout time. These ranges could be as brief as 5, 10, 15, and 30 seconds, or as long as 5, 10, 15, and 30 minutes, depending upon the desires of the user, the sensitivity of the network and computer content, and other factors. One of skill in the art will recognize that other times both greater and smaller than those described above could be implemented on the device for the lockout time, and the only limitations are the switching speed of the microcontroller and the relay and the time required to perform the routines described herein.

Another use of the LEDs 30 is as an indicator of time remaining until the relay 24 will be opened or the time elapsed since the last use of a peripheral device. Once the lockout time has been set, either using the default value from an initialization step or as set by the user, and once the security device 10 has exited from the set lockout time mode, all of the LEDs can be illuminated. As the timer counts, during set intervals within the total lockout time, one of the LEDs can be extinguished. For example, if the lockout time is set by the user at 30 minutes, each LED can represent a 10-minute interval within the 30-minute lockout time interval. Thus, after the last I/O signal from the keyboard 12 or mouse 14 is received by the microcontroller and the timer is reset to 0, all of the LEDs are turned on. After 10 minutes, one of the LEDs is extinguished. After 20 minutes, a second LED is extinguished. After 25 minutes, the last LED is extinguished, and, after 30 minutes, the active LED 32 is extinguished and the inactive LED 34 is turned on. Other embodiments where, for example, the last remaining LED flashes during the last 5 minutes of the lockout time interval to get the user's attention are also possible and considered within the scope of the present disclosure.

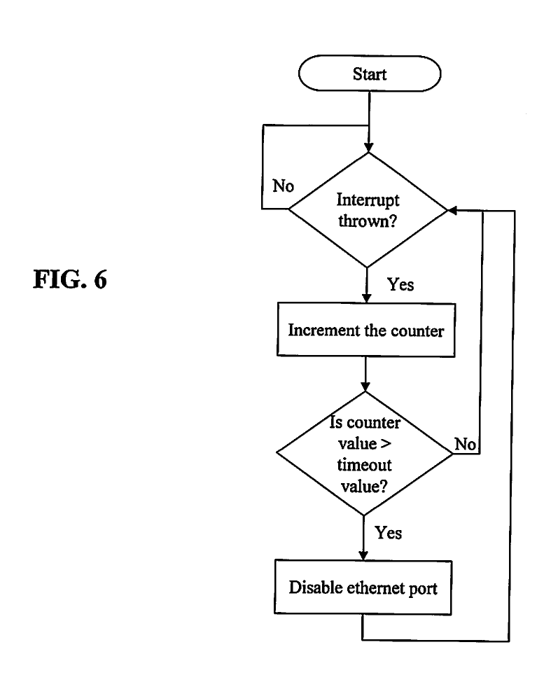

FIG. 6 is a flow diagram of an interrupt service routine in accordance with a further embodiment of the present disclosure. When an interrupt is thrown, an internal counter or timer is incremented. Then, it is determined whether the counter value is greater than a preset lockout time. If the counter value is greater than the lockout time, then the connection between the computer 16 and the network is severed and the interrupt service routine ends. If the counter value is not greater than the timeout value, then the interrupt service routine ends. The interrupt service routine may be called and executed at periodic intervals determined by a timer internal to the security device.

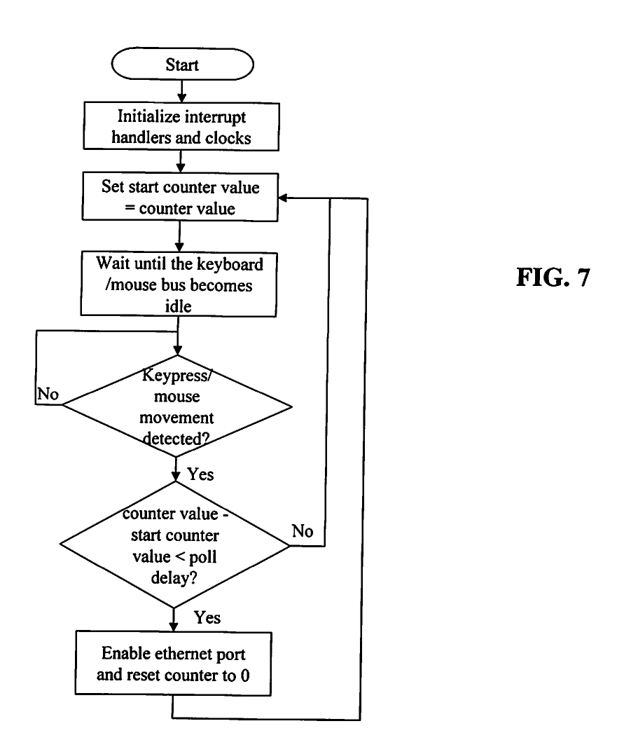

FIG. 7 is a flow diagram of a software routine that is executed while the interrupt service routine (shown in FIG. 6) is repeatedly called. After the software routine starts, the interrupt handlers and clocks are initialized. Then, in the software routine, the start counter value or timer is set equal to the counter value or timer that is incremented in the interrupt service routine (FIG. 6). The start counter value marks the beginning of the next step, in which the processor waits until the peripheral (keyboard and/or mouse) bus becomes idle. This ensures that any activity on the peripheral bus that is not an actual key strike or mouse movement is not incorrectly detected as a key strike or mouse movement. The delay until an idle state of communications on the bus is detected also prevents the false interpretation of a signal originating from the computer side of the security device 10 (or a signal sent from the peripheral device in response to a signal originating from the computer) from being incorrectly interpreted as a I/O signal relating to actual use of the peripheral device.

In the next step, the microcontroller 22 determines whether a key strike or movement of the mouse is detected. If a key strike or movement of the mouse is detected, the microcontroller 22 executes software instructions that determine whether the difference between the counter value and the start counter value is less than a poll delay. The poll delay is the time between poll signals that the keyboard and mouse transmit to the computer when the keyboard and mouse are in an idle state (e.g., when the keyboard and mouse are not actually being used). The poll signals may also originate from the computer 16.

In some embodiments, the poll delay value in the memory of the security device 10 may be set to a value less than the actual poll delay (e.g., the poll delay value may be set to 0.75 seconds when the actual poll delay is 1 second). This ensures that the poll signal is not improperly detected as mouse movement or a key strike. If the difference between the counter value and the start counter value is less than the poll delay value, then the connection between the computer 16 and the network is enabled and the counter is reset to zero. Otherwise, the step in which the start counter value is set equal to the counter value and the subsequent steps are repeated. By having the difference of the counter value and the start counter being less than the poll delay value, and incorporating the delay to wait for an idle state of the bus, the security device 10 can verify that the received signal is the result of an actual key strike or mouse movement.

The computer 16 includes a controller that can transmit messages or packets to a peripheral device after executing a request to send a sequence of instructions. When the peripheral device receives a packet from the controller of the computer 16, it responds by sending a packet to the controller. An adversary could remotely access the controller and attempt to imitate an I/O signal relating to actual use of a peripheral device by sending a data packet to the peripheral device from the computer's controller to cause the keyboard to send a data packet (which is a fake I/O signal relating to actual use of a peripheral) back to the computer.

Typically, however, controllers of the computer 16 do not have sufficiently low level access to allow a user to transmit data packets to the keyboard and mouse. For example, for computers on which the controller is masked-ROM programmed, a user cannot access the controller to transmit data packets to the peripheral device. Thus, the controller itself is not usually considered a vector for attack.

But to prevent such an attack, in yet a further embodiment, the security device 10 may look at the data that is transmitted on the bus between the peripheral device and the computer to determine whether there has been actual use of the peripheral device (e.g. key strike on a keyboard). In this way, the security device 10 of the present disclosure can distinguish between an I/O signal relating to actual use of a peripheral and a response to a signal sent from the computer 16.

Similarly, the device 10 can monitor the data stream for a DFU and prevent that functionality based either on static or dynamic application level protocol filtering, as described above. Said another way, the device 10, and particularly the microcontroller 22, can incorporate the USB firewall (software or firmware) and prevent the rewriting and revision of the firmware resident on the USB devices connected to the computer 16 through the device 10.

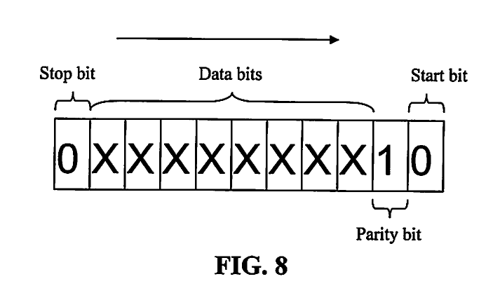

According to one aspect of the present disclosure, to prevent the interpretation of a response of the peripheral device to a signal from the computer from being considered a key strike or mouse movement, the security device 10 monitors the bits of the data packets transmitted by the keyboard or mouse. As shown in FIG. 8, the data packets include eleven bits: a start bit, a parity bit, eight data bits and a stop bit. In some embodiments, the security device 10 looks at the start bit of the data packet to determine whether the data packet relates to an actual use of the peripheral device (e.g., a key press on a keyboard) or merely a response to a computer's request to transmit a signal from the computer 16. For example, a start bit equal to zero may indicate a key press whereas a start bit equal to one may indicate a keyboard's response to a computer's request to transmit a signal to the keyboard. Here again, the security device 10 may wait for a predetermined amount of time (e.g., 1/16^{th} of a second) before monitoring the start bit of the data packets sent from the peripheral device to prevent the interpretation of a portion of a data byte or other signal from being falsely interpreted as a start bit.

In yet a further embodiment, the security device 10 may monitor for signals sent from the computer 16 and ignore any signal sent from the peripheral device for a predetermined time period after sensing a signal sent from the computer 16. In this way, the security device 10 will not incorrectly interpret a response (i.e., an acknowledgement message) to a signal sent from the computer 16 as a key press or movement of the mouse. The security device 10 may sense a signal sent from the computer 16 by detecting a voltage across a resister placed in line with the ports 18 of the security device 10 that connect directly to the computer.

One of skill in the art will readily appreciate that modifications may be made to the disclosed embodiments without departing from the subject and sprit of the disclosure as defined by the following claims.

We claim:

1. A device for preventing the rewriting and revision of the firmware installed on one or more USB devices, the device comprising:
a male Universal Serial Bus (USB) connector connecting the device to a host;
a female USB connector receiving the USB device;
an integrated circuit; and
a detector blocking the transmission of a device firmware update (DFU) from the host to USB device.

2. The device of claim 1, wherein the blocking is configurable by a user.

3. The device of claim 1 further comprising:
a first data connection connecting the host device to the device;
a second data connection connecting the device to a network;
a switch connecting the first and second data connections and permitting the host device to access the network when in a first state and disconnecting the first and second data connections when in a second state; and
a timer determining a time period since the last transmission of signals from the one or more USB devices, wherein when the time period since the last transmission of signals exceeds a predetermined time period an integrated circuit causes the switch to change from the first state to the second state, wherein the integrated circuit receives signals from one or more USB devices and transmits the received signals to a host device.

4. The device of claim 1, further comprising a timer determining a time period since a last transmission of signals from the one or more USB devices, wherein when the time period since the last transmission of signals exceeds a predetermined time period an integrated circuit signals the detector to block the transmission of the device firmware update, and wherein the integrated circuit signals the detector to allow the transmission of the device firmware update when another transmission of signals from the one or more USB devices occurs.

5. The device of claim 4, wherein the integrated circuit signals a computer to display a pop-up dialog box to request permission to update the device firmware.

6. A USB device comprising:
an integrated circuit; and
a detector blocking the receipt of a device firmware update (DFU) from a host.

7. A method of preventing rewriting of the firmware on a USB device, the method comprising:
detecting the transmission of a device firmware update (DFU) from a host device to a USB device; and
blocking the receipt of the DFU by the USB device.

8. The method of claim 7, wherein the blocking is configurable by a user.

9. The method of claim 7, further comprising controlling access to a network.

10. The method of claim 9, wherein controlling the access to the network comprises:
receiving at an integrated circuit signals from the USB device and transmitting the received signals a host device;
connecting via a switch first and second data connections when said switch is in a first position;
disconnecting via the switch the first and second data connections when the switch is in a second position; and
counting a time period since the last transmission of signals from the USB device, wherein when the time period since the last transmission of signals exceeds a predetermined time period the integrated circuit causes the switch to change from the first position to the second position.

11. A computer program product, comprising a computer readable recording medium having a computer readable program code embodied therein, said computer readable program code adapted to execute a method of preventing the rewriting of the firmware on a USB device, said method comprising:
providing a system including at least a host and a USB device;
detecting the transmission of a device firmware update (DFU) from a host device to a USB device; and
blocking the receipt of the DFU by the USB device.

12. The computer program product of claim 11, wherein the blocking is configurable by a user.

13. The computer program product of claim 11, further comprising controlling access to a network.

14. The computer program product of claim 13, wherein controlling the access to the network comprises:
receiving at an integrated circuit signals from the USB device and transmitting the received signals the host device;
connecting via a switch first and second data connections when said switch is in a first position;
disconnecting via the switch the first and second data connections when the switch is in a second position; and
counting a time period since the last transmission of signals from the USB device, wherein when the time period since the last transmission of signals exceeds a predetermined time period the integrated circuit causes the switch to change from the first position to the second position.

15. The computer program product of claim 11, wherein the method further comprises:
determining a time period since a last transmission of signals from the one or more USB devices;
signaling the detector to block the transmission of the device firmware update when the time period since the last transmission of signals exceeds a predetermined time period;
signaling the detector to allow the transmission of the device firmware update when another transmission of signals from the one or more USB devices occurs.

16. The computer program product of claim 15, wherein the method further comprises signaling a computer to display a pop-up dialog box to request permission to update the device firmware
